(19) United States
(12) Patent Application Publication
(10) Pub. No.: US 2002/0064282 A1
(43) Pub. Date: May 30, 2002

(54) Decryption key management in remote nodes

(76) Inventors: Dmitrii Loukianov, Chandler, AZ (US); Howard Harte, Scottsdale, AZ (US); Jabe A. Sandberg, Chandler, AZ (US)

Correspondence Address: FISH & RICHARDSON, PC, 4350 LA JOLLA VILLAGE DRIVE, SUITE 500, SAN DIEGO, CA, 92122, US

(21) Appl. No.: 09/727,104

(22) Filed: Nov. 29, 2000

(51) Int. Cl. H04L 9/00

(52) U.S. Cl. 380/277

(57) ABSTRACT

A system of managing security in a cable modem. Rules are defined enabling a host migrated cable modem to maintain security at specified times. The security is maintained by writing encryption keys to a register only when they are detected as being received in an authorized way. When the decryption keys have been received in an unauthorized way, then they can be received, but not used for decryption purposes. The register in includes a write enable function which enables writing the keys associated with a specified service ID. The register also includes a key destruction function.

### BACKGROUND

DOCSIS cable modem networks may control access to data using security and encryption techniques.

A current way of operating a DOCSIS cable modem uses data encryption standard (DES) encryption to restrict cable modem users from accessing data which they are not authorized to access. Different kinds of network data may be restricted.

One class of cable modem network data that is often restricted is so-called “multicast” data. This is data that is transmitted to more than one cable modem. The multicast data should be made accessible to a given group of cable modems on the network. It must, however, remain inaccessible to those cable modems that are not in the group. By preventing access to the unauthorized cable modems, those unauthorized cable modems are prevented from stealing the data service.

The cable head end controls the access to the multicast data by transmitting DES decryption keys in a “unicast” mode. The keys are sent individually, and are sent to only those cable modems that request the access and are also authorized to access the specified data. The decryption keys themselves may be encrypted using, for example, triple CES or some other algorithm.

Other applications may also exist for allowing certain cable modems to access data while preventing other cable modems from accessing the data.

### BRIEF DESCRIPTION OF THE DRAWINGS

These and other aspects will now be described in detail with reference to the accompanying drawings, wherein:

FIG. 1 shows a CCCM implementation of key extraction.

FIG. 2 shows how key extraction in a host migrated cable modem may cause a security threat;

FIG. 3 shows a MAC chip and its decryption key handling capabilities;

FIG. 4 shows more detail of the arrangement of the key material register bank;

FIG. 5 shows a flowchart of security measures;

FIG. 6 shows this system being used for more generalized protection.

### DETAILED DESCRIPTION

It is often considered to be an unacceptable security breach if an unauthorized cable modem can gain access to unauthorized data. For example, a breach would be established if the cable modem could receive and use a DES decryption key that is not intended for that specific cable modem.

A conventional cable modem achieves this security by modifying the hardware in a way that ensures this kind of security. The conventional cable modem only accepts unicast transmissions that are addressed to the specific cable modem. The hardware within the modem rejects all other unicast transmissions. The cable modem only accepts keys from cable unicast transmissions.

The cable modem is configured to reject keys that are from any other source, such as from the host computer. The cable modem is also prohibited from sending any key reading material outside the cable modem.

For example, the cable modem CPU (central processing unit)/and or MAC (media access controller) chips will extract and use the multicast key internally. The hardware is configured to prevent the keys from being sent outside the cable unit.

This security can be addressed easily in hardware for a conventional cable modem in which many of the operations are carried out in hardware. However, this becomes more complicated in certain new cable modems called “host-migrated modems”, or CPE controlled cable modems or CCCMs. In CCCMs, many of the functions of these modern cable modems are migrated to software that runs on the host computer.

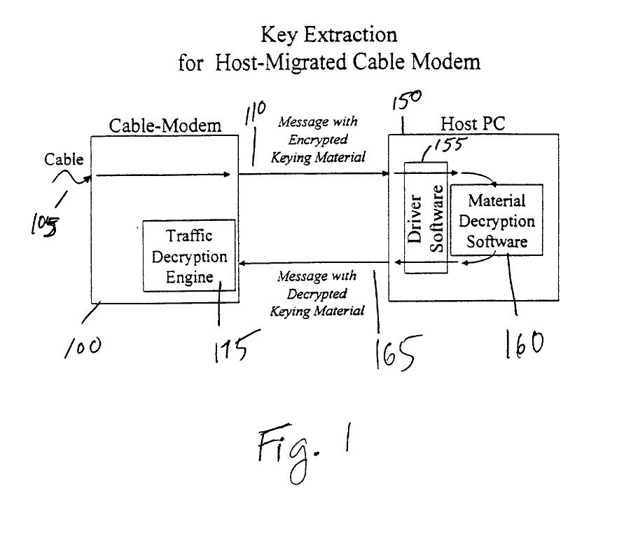

Since parts of the functions of the cable modem runs in the host computer, the present inventors recognize the desirability of migrating key extraction to the host computer. FIG. 1 shows a CCCM implementation of key extraction.

The cable modem 100 receives a message 105 which includes encrypted key reading material which is passed through the cable modem as 110 to the host PC 150. Driver software 155 running in the host PC receives the key ring material and a decryption software layer 160 decrypts the keyring material and returns that decrypted key ring material 165 to the cable modem 100.

A traffic decryption engine 115 running in the cable modem 100 receives the decrypted key ring material and uses that material 165 for decrypting certain data.

However, the host PC (personal computer) 150, in this situation, may obtain access to the key ring material. Moreover, this action may pose a security violation, since this means that the host migrated cable modem must accept keys from an external source. The PC is an inherently insecure element, since the user has access to its operating system and operation techniques of the PC.

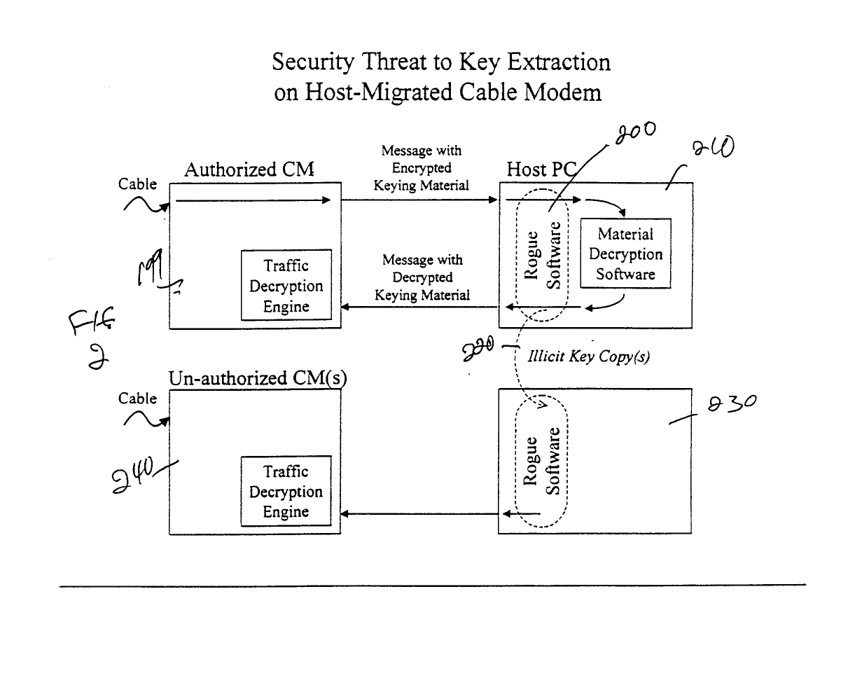

For example, as shown in FIG. 2, a modem 199 receives encrypted key ring material over its cable connection. This message with encrypted key ring material is sent to the host PC 210. A rogue software component 200 on PC 210 could intercept keys on that PC 210. Those keys could then be retransmitted at 220 to an unauthorized modem on another PC 230. The transmission can be via the existing cable channel (“in band”) or over some other channel (“out of band”) such as by telephone modem. That unauthorized modem 240 could then steal the service intended for the authorized modem 199.

The present application defines a host migrated cable modem with special key handling security which avoids this security issue.

The special security operates to only accept keys which are sent in a specified away. In one embodiment disclosed herein, the cable modem only accepts keys from cable unicast transmissions, and not from any other source.

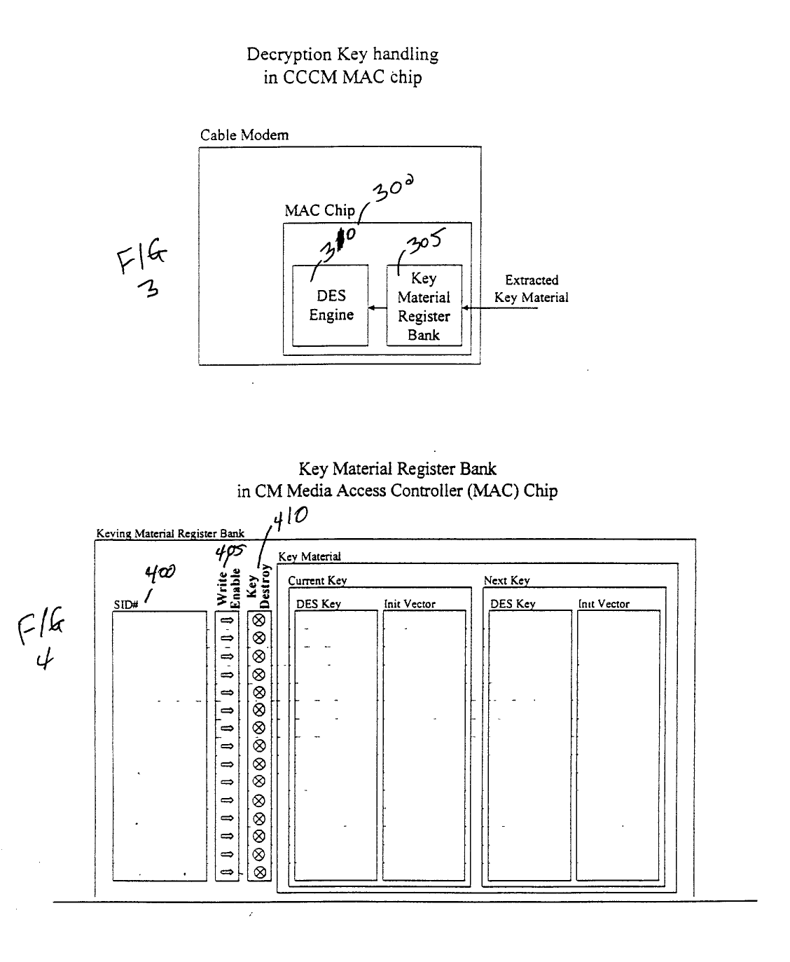

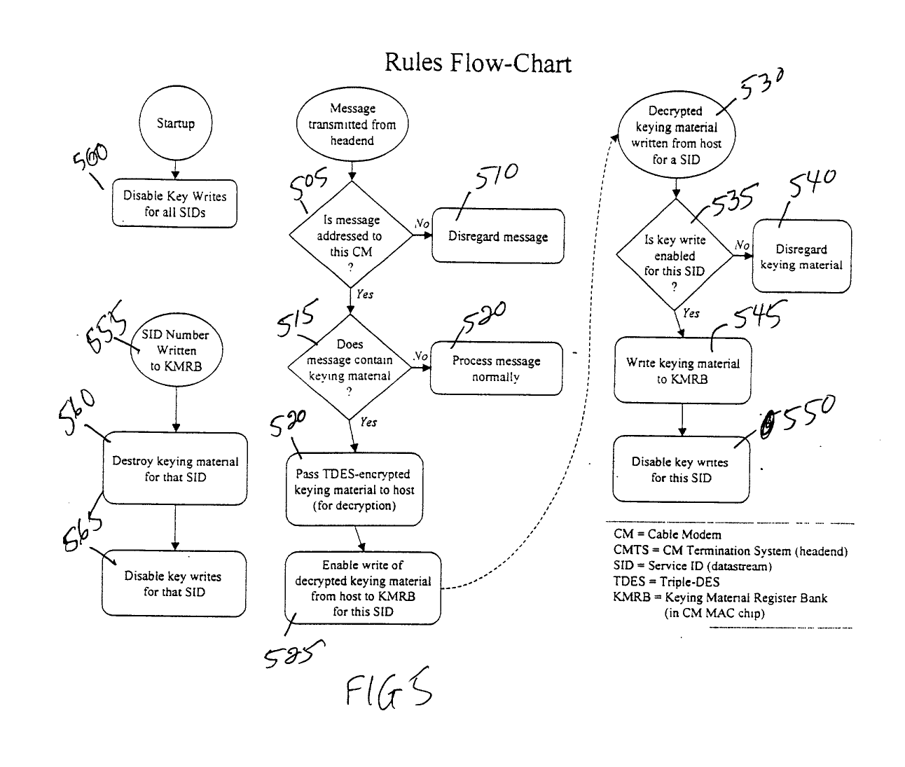

In the specific cable modem described herein, a media access controller (MAC) chip 300 is used to carry out parts of key management. The Mac chip 300 includes a key material register bank 305 and a DES decryption engine 310 as shown in FIG. 3. Both of these blocks 305 and 310 are implemented totally in hardware, thereby allowing them to be considered as secure. The key material register bank 305 stores a key set for each data service flow as identified by its service ID. The key material register bank is shown in more detail in FIG. 4. Each service ID 400 includes different storage areas which enable write enable, key destroy, and the actual key material.

In this system, a key can only be used and accepted by the DES decryption engine 310 after it has been successfully placed into the key material register bank 305 that is stored physically within the media access controller chip 300.

The key material register bank 305 also includes a write enable function 405 for each service ID, and a key destroy function 410 for each service ID.

In operation, various restrictions are imposed on acceptance and/or use of a key which is obtained from the host PC. This compares with previous systems which have allowed acceptance and use of any key at any time. The restrictions are implemented by the above-described write enable and write disable, as well as key invalidation and/or destruction.

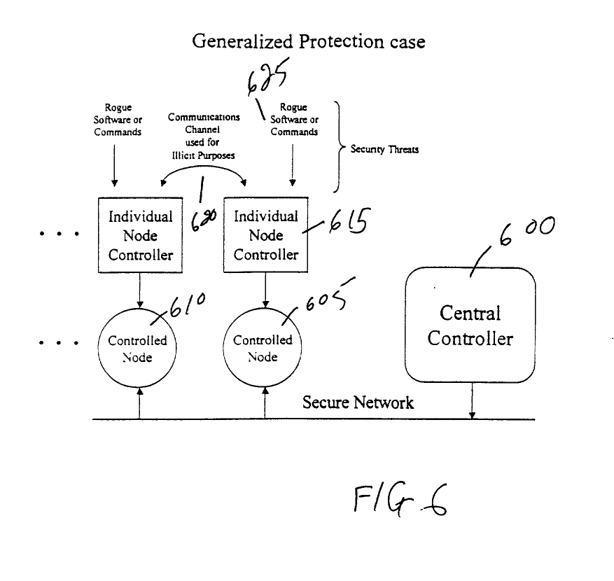

Rules for key management are also provided. The rules are illustrated in the flowchart of FIG. 5. According to this flowchart, the system starts up at 500 with all keys for all service IDs being disabled. This means that no service ID can write a key to the register until something changes after startup. This provides a first basis for key security.

Additional rules are also defined. A cable modem only receives messages on the cable that are addressed to the specific cable modem.

At 505, the system determines if a current message is addressed to the current cable modem. If not, the message is disregarded at 510. This provides a mechanism for the head end to securely address a particular cable modem at a particular time.

If the current message is properly addressed at 505, then 515 determines if the message contains key ring material. A message which does not contains key ring material is processed normally at 520. If the message does contain key ring material at 515, then another rule is executed, for the specific service ID. This enables writing of the key material, and using the key ring material at legitimate times. Legitimacy can be determined by the network's existing security mechanisms.

At 520, the encrypted key ring material is passed to the host for decryption. At 525, write enable for the specific service ID within the material is enabled. This enables writing that decrypted key ring material from the host, to the key material register bank, for the specified service ID.

At 530, the decrypted key ring material is received. The buffer determines at 535 if key write is enabled for the specific ID. If not, then the key ring material is disregarded at 540. If key write has been enabled for the specified service ID at 535, then the key ring material is written at 545. As soon as key ring material is written, key write is disabled shown as 550. This limits key writing to legitimate times only.

An extra aspect may disable key write for some given length of time, regardless of other operations, after a first writing. This extra technique would be executed after 550 if desired. If the new service ID number has been written to the key storage register bank at 555, then key ring material for that service ID is destroyed at 560. Key write for that service ID is also disabled at 565. This protects the security system from a subversion of receiving legitimate key messages that are intended for one lower value service ID, and then using the write enable opportunity to write key ring material for a different, e.g., higher value, service ID.

These rules do not prevent the keys from being obtained illicitly, but rather prevent those keys from being used in an unauthorized cable modem. The rogue key ring material can still be distributed. However, it cannot be used once distributed.

The DOCSIS cable modem key distribution scheme also permits use of authorization keys. These are derived key encryption keys. Similar techniques can be used to protect these other keys. However, by protecting keys which are transmitted in a unicast mode, all other keys and key techniques can be similarly protected.

While the above has described operation in a host migrated cable modem, this system can be used in other cable modems including non host migrated modems. This can increase the security on the cryptographic system, even though existing cable modems are already considered to be secure.

This system can also be used in other types of modems besides cable modems and can be used in any other type modem in which encryption keys may be transmitted. This system can also be used in simple network management protocol (SNMP) where access to certain information or controls in the modem must be controlled. The SNMP messages may be delivered by insecure paths or methods, since these techniques prevent keys within the message from being used unless they meet the specified requirements.

This system may also have application beyond modems, i.e. to other type equipment that have remote control capabilities from a secure controller to one or a plurality of controlled nodes. Remote control commands issued by the secure controller must pass through insecure processing and/or channels before being received or applied by the equipment. This could include cable boxes or other set-top boxes, home gateways, industrial automation and/or telemetry equipment.

The generalized protection case is shown in FIG. 6. In this case, this same system is used to protect a more generalized system. A central controller 600 is shown controlling controlled nodes 605, 610. Each controlled node such as 605 includes an individual node controller 615. The node controllers are connected by a communication channel 620. This communication channel can be the Internet, a wireless channel, or any other form of communication between the noted controllers. Each node controller is capable of receiving rogue software or commands 625. These are generically shown as security threats.

In this system, the same techniques are used as described above to securely detect remote control events, provide a remote control gating, and/or apply the contents from the processed messages only been enabled by the secure controller. After that control command, acceptance may be disabled.

Other modifications beyond those described herein are also possible. All such modifications are intended to be encompassed within the following claims.

What is claimed is:

1. A cable modem comprising:
a controller, monitoring incoming cable modem transmissions for decryption keys, and monitoring conditions when the decryption keys are received; and
a register, storing said decryption keys only when said conditions meet the specified criteria.

2. A cable modem as in claim 1, wherein said cable modem includes a key processing element which causes said keys to be processed by software.

3. The cable modem as in claim 1, wherein said cable modem is a host migrated cable modem in which a host PC processes the keys.

4. A cable modem as in claim 1, wherein said register includes a write enable function, which allows information to be stored in said register only when said write enable function is in a specified condition.

5. A cable modem as in claim 4, wherein said controller allows operation with decryption keys only when said decryption keys are stored in said register.

6. A cable modem as in claim 1, wherein said register includes a key destroy function, which allows a decryption key stored in said register to be marked as an invalid key, and prevents said key from being used for subsequent operations.

7. A cable modem as in claim 1, wherein said register stores a plurality of decryption keys, each decryption key being uniquely associated with a specified identification number indicative of services for which the decryption key is applicable.

8. A cable modem as in claim 1, wherein said register further includes a write enable function, associated with each identification number, and which enables keys to be stored in said register associated with said write enable function only when said write enable function is in a specified state.

9. A method of controlling a cable modem, comprising:
monitoring an incoming cable stream for a decryption key;
if a decryption key is present, then decrypting said decryption key in a host PC that is associated with the cable modem, but separate from the cable modem; and
allowing said decryption key to be used for decrypting said cable stream, only when said decryption key has been received in a specified way, otherwise not allowing said decryption key to be used for decrypting said cable stream.

10. A method as in claim 9 wherein said specified way includes that said decryption key was received over the cable medium.

11. A method as in claim 9, wherein said specified way includes that the decryption key was received associated with a particular service ID.

12. A method as in claim 9, wherein said specified way includes that the decryption key is stored in a specified register.

13. A method as in claim 9, further comprising storing the decryption key in a specified register when the allowing determines that said decryption key has been received in the specified way.

14. A method as in claim 13, further comprising allowing said decryption key to be used only when the decryption key is stored in the register.

15. A method as in claim 9 wherein said specified way includes requiring said decryption key to meet each of a plurality of specified rules.

16. A method as in claim 15 wherein said specified rules include key writing to a decryption engine being normally disabled.

17. A method as in claim 15 wherein at least one of said specified rules defines that the cable modem only receives messages on the cable that are addressed to the specified cable modem, and disregards messages which are addressed to other than specified cable modem.

18. A method as in claim 15 wherein at least one of the-specified rules include that a specified service ID for specified key ring material causes key write capability to be enabled for said that specified service ID.

19. A method as in claim 18 further comprising an additional rule which disables key write for said service ID after key ring material is written to a storage area associated with said service ID.

20. A method as in claim 18, further comprising an additional rule which disables key write for said service ID, for specified time after writing said key ring material.

21. A method as in claim 15 wherein at least one of said specified rules include that the cable modem receives key ring material, writes said key ring material, and then destroys said key ring material.

22. A system comprising:
a networked system of nodes, each said node being uniquely controlled according to a unique identifier; at least one secure controller, said secure controller including a capability of providing permission to said nodes individually, according to said unique identifier;
wherein each said node includes a secure event detection element capable of receiving an encryption key from said secure controller, and a memory, storing said encryption key only when specified conditions occur.

23. A system as in claim 22 were each said node is a cable modem.

24. An article comprising a computer readable media, comprising instructions causing the computer to:
monitor, in a first unit, a data stream for incoming keys of a specified format;
send said keys to another unit, other than said first unit, for decryption; and
enable use of said keys only when the keys are received from the data stream in a specified way.

25. An article as in claim 24, wherein the stream is a stream of cable modem information.

26. An article as in claim 25, wherein said keys are DES encryption keys.

27. An article as in claim 24, further comprising storing the keys in a specified location when they are received in the specified way.

28. An article as in claim 27, wherein said keys are enabled for use only when they are stored in the specified location.

29. An article as in claim 28 further comprising instructions enabling writing only when specified conditions occur.

30. An article as in claim 28 further comprising instructions enabling specified keys to be destroyed.
